(19) United States
(12) Patent Application Publication
(10) Pub. No.: US 2025/0063964 A1
(43) Pub. Date: Feb. 27, 2025

(54) ROW CLEANER ARRANGEMENT FOR ROW UNITS OF AN AGRICULTURAL IMPLEMENT

(71) Applicant: CNH Industrial America LLC, New Holland, PA (US)

(72) Inventors: William E. Preller, Congerville, IL (US); Austin Joseph Lewandowski, Congerville, IL (US); Brian Michael Craig, Congerville, IL (US)

(21) Appl. No.: 18/807,314

(22) Filed: Aug. 16, 2024

Related U.S. Application Data
(60) Provisional application No. 63/578,742, filed on Aug. 25, 2023.

(51) Int. Cl. A01B 15/16; A01B 15/18

(52) U.S. Cl. CPC A01B 15/16; A01B 15/18

(57) ABSTRACT

In one aspect, a row unit configured for use with an agricultural implement includes a frame and a coulter supported by the frame and extending in a fore-aft direction of the row unit along a longitudinal centerline of the row unit. The row unit also includes a row cleaner supported by the frame relative to the coulter, with the row cleaner including first and second row cleaner disc. The first and second row cleaner discs are arranged relative to the coulter such that an initial point of engagement of the coulter with soil being processed by the row is located: (1) aft of soil entry locations of the first and second row cleaner discs in the fore-aft direction; and (2) forward of soil exit locations of the first and second row cleaner discs in the fore-aft direction.

### CROSS-REFERENCE TO RELATED APPLICATIONS

The present application is based upon and claims the right of priority to U.S. Provisional Patent Application No. 63/578,742, filed Aug. 25, 2023, the disclosure of which is hereby incorporated by reference herein in its entirety for all purposes.

### FIELD OF THE INVENTION

The present subject matter relates generally to agricultural implements, such as strip tillage implements and, more particularly, to a row cleaner arrangement for row units of an agricultural implement.

### BACKGROUND OF THE INVENTION

Many agricultural implements include row units for processing a narrow strip of soil during the performance of an agricultural operation. For instance, planters include planter row units for opening a furrow along a narrow strip of soil, depositing a seed within the furrow, and then subsequently closing the furrow. Similarly, strip-tillage implements include strip-tillage row units for tilling a narrow strip of soil to prepare the soil for subsequent planting.

In many instances, row units may include a row cleaner positioned at the forward end of the row unit for removing residue or other trash along the path of the row unit. For example, a strip-tillage row unit may often include a row cleaner including a pair of row cleaner discs positioned at the forward end of the row unit. Typically, the ground-engaging portions of the row cleaner discs are positioned entirely in front or forward of the remainder of the downstream ground-engaging tools of the row unit. As such, these row cleaner discs generally work in isolation relative to the other ground-engaging tools to perform their residue cleaning function.

Accordingly, an improved row cleaner arrangement for a row unit of an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a row unit configured for use with an agricultural implement. The row unit includes a frame and a coulter supported by the frame and extending in a fore-aft direction of the row unit along a longitudinal centerline of the row unit. The row unit also includes a row cleaner supported by the frame relative to the coulter, with the row cleaner including first and second row cleaner disc. The first and second row cleaner discs are arranged relative to the coulter such that an initial point of engagement of the coulter with soil being processed by the row is located: (1) aft of soil entry locations of the first and second row cleaner discs in the fore-aft direction; and (2) forward of soil exit locations of the first and second row cleaner discs in the fore-aft direction.

In another aspect, the present subject matter is directed to an agricultural implement. The implement includes a frame and a plurality of row units supported relative to the frame. Each row unit includes a row unit frame and a coulter supported by the row unit frame and extending in a fore-aft direction of the row unit along a longitudinal centerline of the row unit. Each row unit also includes a row cleaner supported by the row unit frame relative to the coulter, with the row cleaner including first and second row cleaner discs. The first and second row cleaner discs are arranged relative to the coulter such that an initial point of engagement of the coulter with soil being processed by the row is located: (1) aft of soil entry locations of the first and second row cleaner discs in the fore-aft direction; and (2) forward of soil exit locations of the first and second row cleaner discs in the fore-aft direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of a front portion of the row unit shown in FIG. 2, particularly illustrating the relative positioning between the row cleaner and the center coulter of the row unit;

FIG. 4 illustrates a top view of the front portion of the row unit shown in FIG. 3;

FIG. 5 illustrates a side view of the front portion of the row unit shown in FIG. 3 with the row cleaner disc positioned along the far side (relative to the view of FIG. 5) of the row unit removed for purposes of illustration; and

FIG. 6 illustrates another side view of the front portion of the row unit shown in FIG. 3 with the row cleaner disc positioned along the near side (relative to the view of FIG. 6) of the row unit removed for purposes of illustration.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an improved row cleaner arrangement for a row unit of an agricultural implement. In several embodiments, the row cleaner discs of the row cleaner are arranged relative to a center coulter of the row unit such that the row cleaner and center coulter function or work in combination to perform a residue cleaning or clearing function for the row unit. Specifically, in accordance with aspects of the present subject matter, the row cleaner discs may be arranged relative to the center coulter such that an initial point or location of soil engagement of the center coulter is located between associated soil entry and soil exit locations for the row cleaner discs in a fore-aft direction of the row unit. As will be described below, such an arrangement allows the row cleaner discs to trap residue against the soil while the coulter functions to slice or cut through the trapped residue, thereby allowing residue to be more effectively and efficiently cleared or swept away from the row of soil being processed by downstream ground-engaging tools of the row unit.

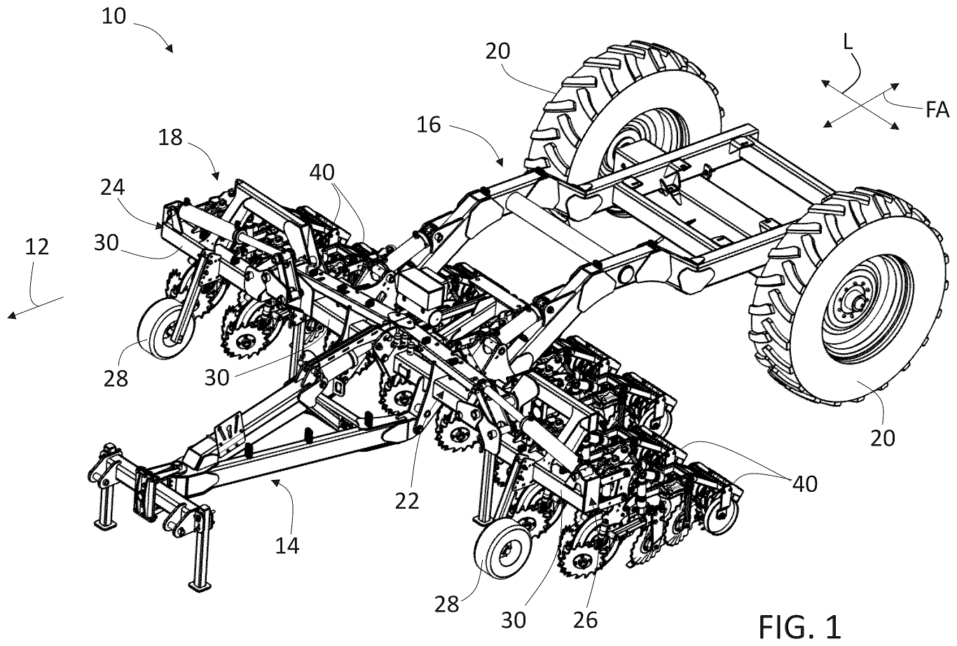

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

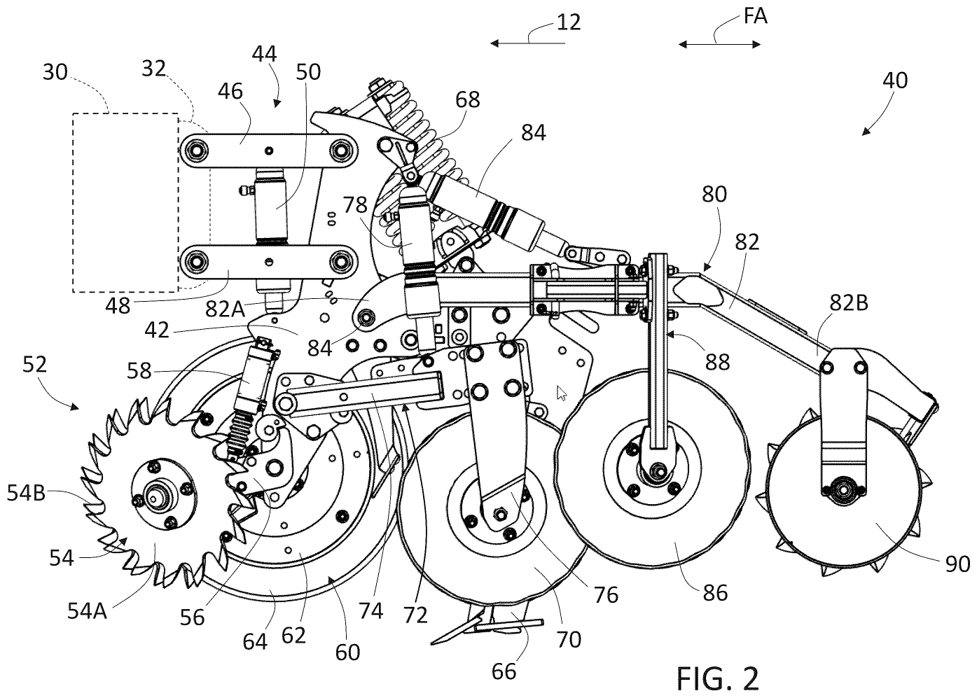

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

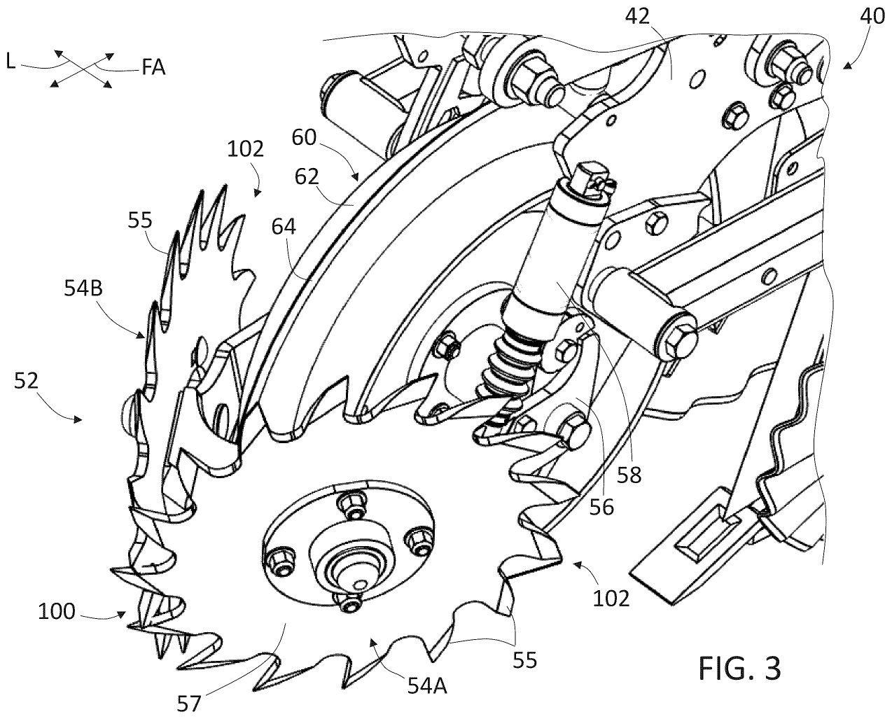

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (e.g., a first row cleaner disc 54A and a second row cleaner disc 54B), with each disc 54 being pivotably coupled to the main frame via a row cleaner arm 56. As is generally understood, the row cleaner discs 54 may be toothed or spiked, such as by including a plurality of fingers or teeth 55 (FIGS. 3-6) extending radially outwardly from a central disc hub 57 (FIGS. 3-6). As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes one or more row cleaner actuators 58 configured to provide a downward biasing force against the row cleaner 52, with the row cleaner actuator 58 being coupled between the main frame 42 and the row cleaner arm 56. In one embodiment, the row cleaner actuator(s) 58 may be passive actuators, such as air shocks or springs. Alternatively, the row cleaner actuator(s) 58 may be actively controlled actuators, such as pneumatic or hydraulic cylinders.

Moreover, as shown in FIG. 2, the row unit 40 may also include a center coulter 60 positioned generally adjacent the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, as will be described below, the relative positioning between the row cleaner discs 54 and the center coulter 60 may allow such component to efficiently and effectively process residue in the path of the row unit 40. Specifically, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

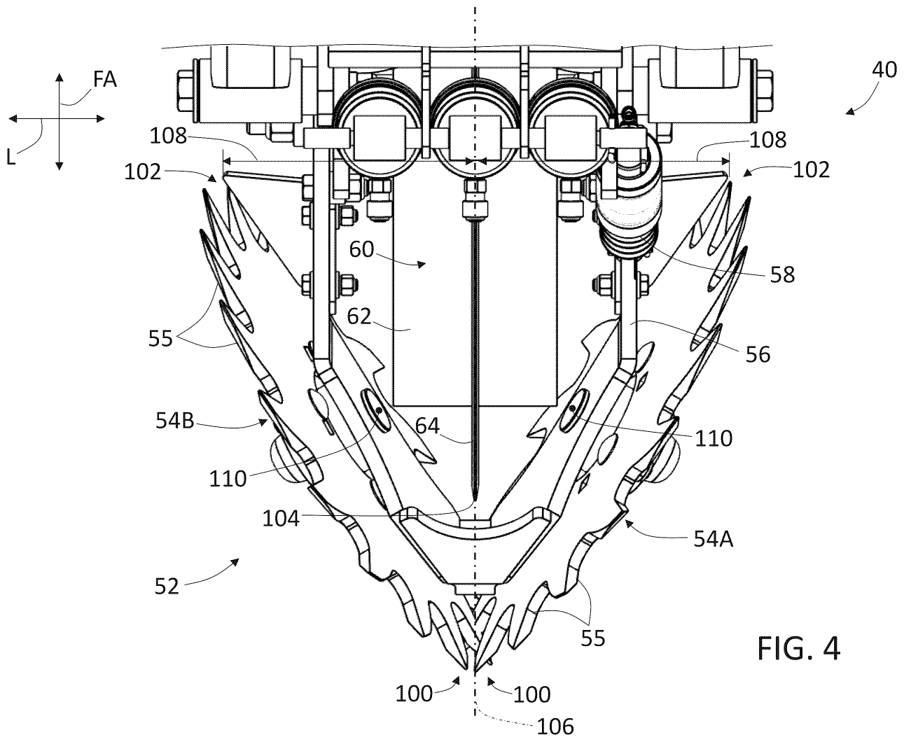

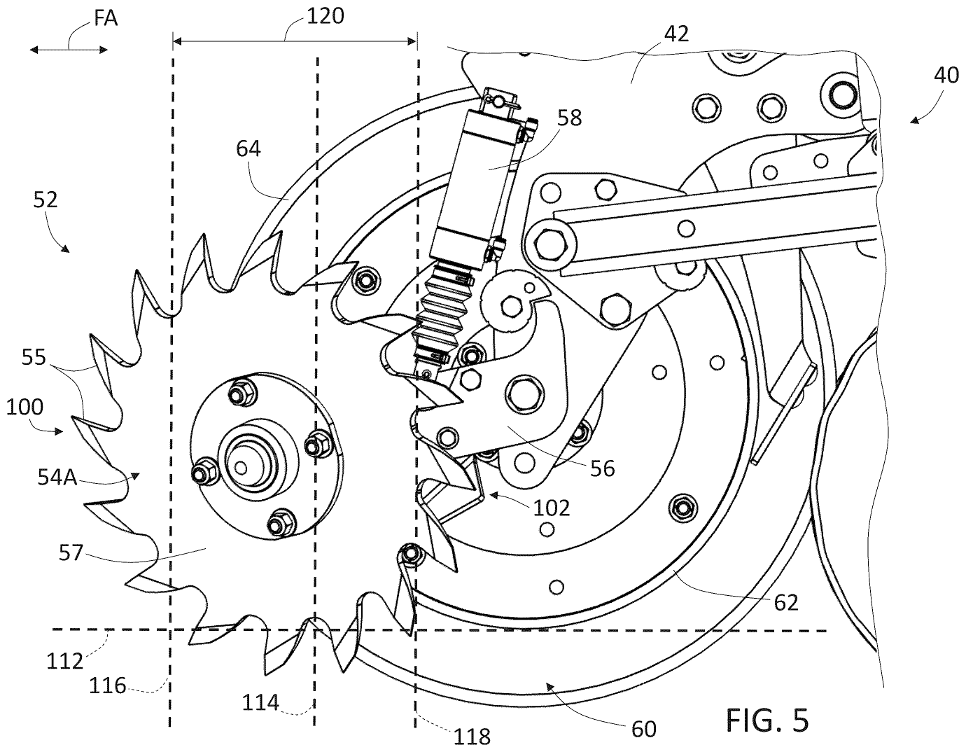

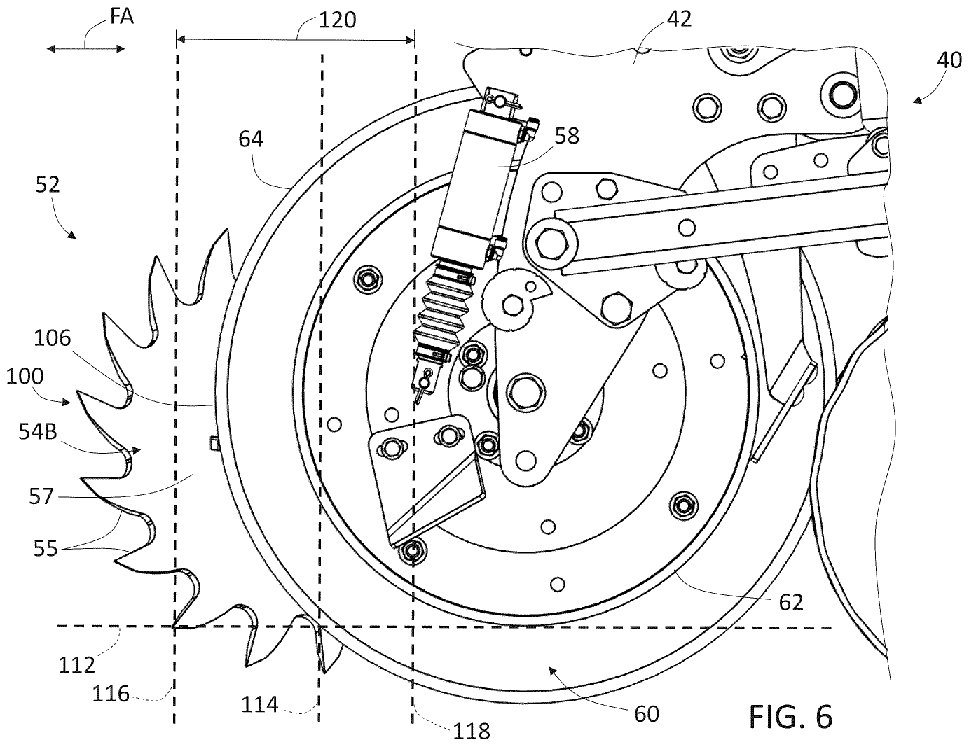

Referring now to FIGS. 3-6, several views of a portion of the front end of the row unit 40 shown in FIG. 2 are illustrated in accordance with aspects of the present subject matter. Specifically, FIGS. 3 and 4 illustrate perspective and top views, respectively, of the front end of the row unit 40 shown in FIG. 2, particularly illustrating the relative positioning between the first and second row cleaner discs 54A, 54B of the row cleaner 52 and the center coulter 60. FIG. 5 illustrates a side view of the portion of the front end of the row unit 40 shown in FIG. 3 with the row cleaner disc positioned along the far side (relative to the view of FIG. 5) of the row unit 40 (i.e., the second row cleaner disc 54B) removed from the illustration to particularly show the relative positioning between the other row cleaner discs (i.e., the first row cleaner disc 54A) and the center coulter 60 as such components are engaging the ground during the performance of a strip tillage operation. Similarly, FIG. 6 illustrates another side view of the portion of the front end of the row unit 40 shown in FIG. 3 with the row cleaner disc positioned along the near side (relative to the view of FIG. 6) of the row unit 40 (i.e., the first row cleaner disc 54A) and related mounting structure (e.g., including the row cleaner arm 56) removed from the illustration to particularly show the relative positioning between the other row cleaner disc (i.e., the second row cleaner disc 54B) and the center coulter 60 as such components are engaging the ground during the performance of a strip tillage operation.

As shown in the illustrated embodiment, the row cleaner 52 and center coulter 60 may generally be configured to positioned relative to one another in the fore-aft direction of the row unit 40 (indicated by arrow FA in FIGS. 3-6) such that the components overlap each other in the lateral direction of the row unit (indicated by arrow L in FIGS. 3 and 4, which is the directed into and out of the page in FIGS. 5 and 6). For example, as shown in FIGS. 3 and 4, the row cleaner discs 54A, 54B generally extend in the fore-aft direction FA between a forward end 100 of each disc 54A, 54B and an aft end 102 of each disc 54A, 54B, with the forward ends 100 of the row cleaner discs 54A, 54B being positioned in front or forward of the center coulter 60 relative to the fore-aft direction FA and the aft ends 102 of the row cleaner discs 54A, 54B being positioned aft of a forwardmost edge 104 (FIGS. 4 and 6) of the blade 64 of the center coulter 60 relative to the fore-aft direction FA. As particularly shown in FIG. 4, the row cleaner discs 54A, 54B are angled outwardly relative to a longitudinal centerline 106 of the row unit 40 as the discs 54A, 54B extend between their forward and aft ends 100, 102. Specifically, the row cleaner discs 54A, 54B are oriented such that the forward ends 100 of the discs 54A, 54B are generally aligned with both the lateral centerline 106 and the center coulter blade 64 in the fore-aft direction FA, with the teeth 55 of the row cleaner discs 54A, 54B at such ends 100 being configured to mesh or overlap one another as the discs 54A, 54B rotate relative to the ground. Similarly, due to the angular orientation of the row cleaner discs 54A, 54B, the aft ends 102 of the discs 54A, 54B are spaced apart from the lateral centerline 106 by a given lateral distance 108 (FIG. 4), with each aft end 102 being positioned along an opposed lateral side of the center coulter 60. As a result, the row cleaner discs 54A, 54B generally wrap or extend around a forward portion of the center coulter 60, with the forwardmost edge 104 of the center coulter blade 64 being nested or positioned between the discs 54A, 54B. For example, as shown in FIG. 4, the forwardmost edge 104 of the center coulter blade 64 may be positioned between the forward ends 100 of the discs 54A, 54B and a rotational center of each disc 54A, 54B (e.g., as indicated by points 110 in FIG. 4) in the fore-aft direction FA.

Additionally, as particularly shown in FIGS. 5 and 6, the relative positioning of the row cleaner 52 and the center coulter 60 may be selected such that an initial point of engagement of the center coulter 60 with the soil is positioned between the points at which the row cleaner discs 54A, 54B enter and exit the soil in the fore-aft direction FA. Specifically, in FIGS. 5 and 6, the surface of the soil is generally indicated by a dashed horizontal line 112, with the hub 62 of the center coulter 60 being configured to generally roll along the soil surface 112. Additionally, the initial point of engagement of the center coulter 60 with the soil in the fore-aft direction FA is indicated by a dashed vertical line 114, which generally indicates the point at which the edge of the center coulter blade 65 initially contacts and begins to cut into the soil. Similarly, the “soil entry” and “soil exit” locations for the row cleaner discs 54A, 54B are generally indicated by the dashed vertical lines 116, 118 respectively, with the soil entry location 116 generally indicating the location at which the teeth 55 of each row cleaner disc 54A, 54B initially contact and enter into the soil and the soil exit location 118 generally indicating the location at which the teeth 55 of each row cleaner disc 54A, 54B exit the soil following engagement thereof. As such, portions of the teeth 55 of the row cleaner discs 54A, 54B may generally be positioned below the soil surface 112 between the soil entry and soil exit locations 116, 118. It should be appreciated that, in FIG. 6, the portion of the second row cleaner disc 54B that is exiting the soil is hidden behind the center coulter 60; nonetheless, the soil exit location 118 is marked via the respective dashed line to indicate the position of such portion of the second row cleaner disc 54B relative to the coulter 60.

By arranging the row cleaner discs 54A, 54B relative to the center coulter 60 such that the initial point of soil engagement of the center coulter 114 is positioned aft of the soil entry locations 116 of the row cleaner discs 54A, 54B and forward of the soil exit locations 118 of the row cleaner discs 54A, 54B in the fore-aft direction FA, the row cleaner 52 and center coulter 60 may be configured to work in combination to ensure that residue and other trash is swept or moved laterally away from the travel path of further downstream components of the row unit 40. Specifically, as the row cleaner discs 54A, 54B rotate relative to the ground, the discs 54A, 54B may be configured to trap residue against the soil surface 112 along a residue trapping distance 120 (FIGS. 5 and 6) extending between the soil entry and soil exit locations 116, 118 in the fore-aft direction FA. In this regard, since the initial point of soil engagement of the center coulter 114 is positioned between the between the soil entry and soil exit locations 116, 118, the blade 64 of the center coulter 60 may function to slice or cut through the trapped residue extending between the row cleaner discs 54A, 54B as the blade 60 begins to enter into the soil at location 114. In other words, the row cleaner discs 54A, 54B may be configured to hold the residue in place against the soil surface 112 in a manner that allows the center coulter blade 64 to slice through the residue along the longitudinal centerline 108 of the row unit 40. This sliced or cut residue may then be swept or thrown away from the longitudinal centerline 106 of the row unit 40 via the action of the row cleaner discs 54A, 54B as the discs 54A, 54B exit the soil at the soil exit locations 118.

Additionally, in one embodiment, the arrangement of row cleaner 52 relative to the center coulter 60 may also be selected such that the forwardmost edge 104 of the center coulter blade 64 is located between the soil entry and exit locations 116, 118 of the row cleaner discs 54A, 54B in the fore-aft direction FA. Specifically, as shown in FIG. 6, the forwardmost edge 104 of the center coulter blade 64 is located aft of the soil entry locations 116 of the row cleaner discs 54A, 54B and forward of the soil exit locations 118 of the row cleaner discs 54A, 54B in the fore-aft direction FA. In this regard, in association with the discussion above with reference to FIG. 4, the forwardmost edge 104 of the center coulter blade 54 may also be located between the soil entry locations 116 of the row cleaner discs 54A, 54B and the center of rotation 110 (FIG. 4) of the row cleaner discs 54A, 54B in the fore-aft direction FA.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A row unit configured for use with an agricultural implement, the row unit comprising:
a frame;
a coulter supported by the frame and extending in a fore-aft direction of the row unit along a longitudinal centerline of the row unit; and
a row cleaner supported by the frame relative to the coulter, the row cleaner including first and second row cleaner discs;
wherein the first and second row cleaner discs are arranged relative to the coulter such that an initial point of engagement of the coulter with soil being processed by the row is located: (1) aft of soil entry locations of the first and second row cleaner discs in the fore-aft direction; and (2) forward of soil exit locations of the first and second row cleaner discs in the fore-aft direction.

2. The row unit of claim 1, wherein the coulter includes a hub coupled to the frame for rotation relative thereto and a blade extending radially outwardly from the hub, the blade being aligned with the longitudinal centerline of the row unit in the fore-aft direction.

3. The row unit of claim 2, wherein the initial point of engagement of the coulter with the soil corresponds to a location at which the blade initially contacts the soil in the fore-aft direction.

4. The row unit of claim 3, wherein each row cleaner disc includes a central hub and a plurality of teeth extending radially outwardly from the central hub, the soil entry locations for the first and second row cleaner discs corresponding to locations at which the plurality of teeth are configured to initially contact the soil in the fore-aft direction, the soil exits locations for the first and second row cleaner discs corresponding to locations at which the plurality of teeth are configured to exit the soil in the fore-aft direction.

5. The row unit of claim 2, wherein the blade defines a forwardmost edge of the coulter in the fore-aft direction of the row unit.

6. The row unit of claim 5, wherein the forwardmost edge of the coulter is positioned forward of a center of rotation of each of the first and second row cleaner discs in the fore-aft direction.

7. The row unit of claim 5, wherein the forwardmost edge of the coulter is positioned aft of aft of the soil entry locations of the first and second row cleaner discs in the fore-aft direction.

8. An agricultural implement, comprising:
a frame;
a plurality of row units supported relative to the frame, each of the plurality of row units comprising:
a row unit frame;
a coulter supported by the row unit frame and extending in a fore-aft direction of the row unit along a longitudinal centerline of the row unit; and
a row cleaner supported by the row unit frame relative to the coulter, the row cleaner including first and second row cleaner discs;
wherein the first and second row cleaner discs are arranged relative to the coulter such that an initial point of engagement of the coulter with soil being processed by the row is located: (1) aft of soil entry locations of the first and second row cleaner discs in the fore-aft direction; and (2) forward of soil exit locations of the first and second row cleaner discs in the fore-aft direction.

9. The agricultural implement of claim 8, wherein the coulter includes a hub coupled to the frame for rotation relative thereto and a blade extending radially outwardly from the hub, the blade being aligned with the longitudinal centerline of the row unit in the fore-aft direction.

10. The agricultural implement of claim 9, wherein the initial point of engagement of the coulter with the soil corresponds to a location at which the blade initially contacts the soil in the fore-aft direction.

11. The agricultural implement of claim 10, wherein each row cleaner disc includes a central hub and a plurality of teeth extending radially outwardly from the central hub, the soil entry locations for the first and second row cleaner discs corresponding to locations at which the plurality of teeth are configured to initially contact the soil in the fore-aft direction, the soil exits locations for the first and second row cleaner discs corresponding to locations at which the plurality of teeth are configured to exit the soil in the fore-aft direction.

12. The agricultural implement of claim 9, wherein the blade defines a forwardmost edge of the coulter in the fore-aft direction of the row unit.

13. The agricultural implement of claim 12, wherein the forwardmost edge of the coulter is positioned forward of a center of rotation of each of the first and second row cleaner discs in the fore-aft direction.

14. The agricultural implement of claim 12, wherein the forwardmost edge of the coulter is positioned aft of aft of the soil entry locations of the first and second row cleaner discs in the fore-aft direction.
